(19) United States
(12) Patent Application Publication
(10) Pub. No.: US 2021/0204294 A1
(43) Pub. Date: Jul. 1, 2021

(54) COMMUNICATION METHOD FOR MOBILE TERMINAL AND MOBILE TERMINAL

(71) Applicant: VIVO MOBILE COMMUNICATION CO., LTD., Dongguan (CN)

(72) Inventor: Mingzhi FANG, Dongguan (CN)

(73) Assignee: VIVO MOBILE COMMUNICATION CO., LTD., Dongguan (CN)

(21) Appl. No.: 17/199,323

(22) Filed: Mar. 11, 2021

Related U.S. Application Data
(63) Continuation of application No. PCT/CN2019/105599, filed on Sep. 12, 2019.

(30) Foreign Application Priority Data
Sep. 13, 2018 (CN) 201811067804.8

(51) Int. Cl. H04W 72/04; H04W 16/28

(52) U.S. Cl. CPC H04W 72/0493; H04W 16/28; H04W 72/0453; H04W 72/042

(57) ABSTRACT

This disclosure provides a communication method for a mobile terminal and a mobile terminal. An exemplary mobile terminal includes at least two antennas. An exemplary communication method for the mobile terminal includes controlling a first antenna of the mobile terminal to send, on a target frequency band, a first uplink signal to a first base station. The communication method for the mobile terminal further includes controlling a second antenna of the mobile terminal to receive, on the target frequency band, a first downlink signal sent by a second base station. The first base station is a base station in communication connection to the first antenna. The second base station is a base station in communication connection to the second antenna.

### CROSS-REFERENCE TO RELATED APPLICATIONS

This application is a continuation of PCT Application No. PCT/CN2019/105599 filed Sep. 12, 2019, which claims priority to Chinese Patent Application No. 201811067804.8 filed in China on Sep. 13, 2018, both of which are incorporated herein by reference in their entireties.

### TECHNICAL FIELD

The present disclosure relates to the field of communications technologies, and in particular, to a communication method for a mobile terminal and a mobile terminal.

### BACKGROUND

With improvement of the technology, the current situation of communication cannot meet user needs. To adapt to requirements of various application scenarios, a 5G mobile terminal may further meet user needs to a great extent, and traffic and speed used by a user may also be far greater than that of a 4G mobile terminal in the related technologies. The 5G mobile terminal has a greater radio frequency operating bandwidth, occupies more spectrum resources, has a higher working frequency band, and has features of high-speed transmission and low latency. In addition, the 5G mobile terminal may also be compatible with the original 4G mobile terminal, and uses more spectrum resources, which make already scarce spectrum resources more overstretched.

Mobile terminal communication is divided into uplink signals and downlink signals. An uplink signal is a signal sent by a mobile terminal to a base station. To ensure that after space attenuation, the base station can still perform normal reception and demodulation, the uplink signal has a high power and is strong. A downlink signal is a signal sent by the base station to the mobile terminal. After space attenuation, the downlink signal has a low power and is weak. A strong signal may affect reception and demodulation of a weak signal. To avoid impact of the uplink signal on the downlink signal, the 4G mobile terminal in the related technologies uses two multiplexing modes: frequency division multiplexing and time division multiplexing.

Frequency division multiplexing: The uplink signal and the downlink signal work at the same time point, where time is continuous, but different spectrum ranges are used. Specifically, frequency division multiplexing divides an originally available frequency bandwidth into two same parts. The uplink signal and the downlink signal each occupy a half. A single uplink signal uses only a half of entire available spectrum resources, a single downlink signal also uses only a half of entire available spectrum resources, and spectrum usage efficiency is relatively low. For example, a frequency range of an uplink signal of FDD_B1 is 1920 MHz to 1980 MHz, and a frequency range of a downlink signal of FDD_B1 is 2110 MHz to 2170 MHz. An original available frequency range of 120 MHz is occupied by the uplink signal and the downlink signal, each of which occupies 60 MHz of bandwidth, and a spectrum utilization rate is halved.

Time division multiplexing: The uplink signal and the downlink signal work at different time points, where time is discontinuous, but the same spectrum range is used. Specifically, time division multiplexing divides a continuous time segment into three parts. One part of the time segment is independently occupied by the uplink signal, another part of the time segment is independently occupied by the downlink signal, and the other part of the time segment is set as protection time slot between the uplink time segment and the downlink time segment, so as to prevent the uplink signal and the downlink signal from affecting each other. Therefore, use efficiency of time in time domain is low. For example, in a TDD-LTE system, assuming that an uplink and downlink time ratio is 2:3, utilization rates of the uplink signal and the downlink signal on time are 40% and 60% respectively. If the protection time slot is included, the utilization rates may be lower.

It can be learned that a problem of relatively low use efficiency of a frequency domain and a time domain exists in a communication method between a mobile terminal and a base station in the related technologies.

### SUMMARY

Embodiments of the present disclosure provide a communication method for a mobile terminal and a mobile terminal, so as to resolve a problem of relatively low use efficiency of a frequency domain and a time domain in a communication method between a mobile terminal and a base station in the related technologies.

According to a first aspect, an embodiment of the present disclosure provides a communication method for a mobile terminal, where the mobile terminal includes at least two antennas, and the method includes:

controlling a first antenna of the mobile terminal to send, on a target frequency band, a first uplink signal to a first base station, and in addition, controlling a second antenna of the mobile terminal to receive, on the target frequency band, a first downlink signal sent by a second base station, where

the first base station is a base station in communication connection to the first antenna, and the second base station is a base station in communication connection to the second antenna.

According to a second aspect, an embodiment of the present disclosure provides a mobile terminal, where the mobile terminal includes at least two antennas, and the mobile terminal further includes:

a first control module, configured to: control a first antenna of the mobile terminal to send, on a target frequency band, a first uplink signal to a first base station, and in addition, control a second antenna of the mobile terminal to receive, on the target frequency band, a first downlink signal sent by a second base station, where

the first base station is a base station in communication connection to the first antenna, and the second base station is a base station in communication connection to the second antenna.

According to a third aspect, an embodiment of the present disclosure further provides a mobile terminal, including a memory, a processor, and a computer program stored in the memory and capable of running on the processor, where when the program is executed by the processor, the steps of the foregoing communication method for a mobile terminal are implemented.

According to a fourth aspect, an embodiment of the present disclosure further provides a computer readable storage medium, storing a computer program, where when the program is executed by the processor, the steps of the foregoing communication method for a mobile terminal are implemented.

The embodiments of the present disclosure have the following beneficial effects:

According to the embodiments of the present disclosure, a first antenna is controlled to send an uplink signal to a first base station, and in addition, a second antenna is controlled to receive a downlink signal sent by a second base station, both of which use the same frequency range. At the same moment, the uplink signal and the downlink signal of a mobile terminal use the same frequency range to work simultaneously, and do not affect each other. Therefore, utilization rates of a frequency domain and a time domain by a communications system are improved.

### BRIEF DESCRIPTION OF DRAWINGS

To describe the technical solutions in the embodiments of the present disclosure more clearly, the following briefly describes the accompanying drawings required in the embodiments of the present disclosure. Apparently, the accompanying drawings in the following descriptions show merely some embodiments of the present disclosure.

FIG. 1 is a flowchart of a communication method for a mobile terminal according to an embodiment of the present disclosure;

FIG. 2 is a schematic diagram of a communication principle between a mobile terminal and a base station according to an embodiment of the present disclosure;

FIG. 3 is a schematic diagram of connection between antennas and a baseband processing unit of a mobile terminal according to an embodiment of the present disclosure;

FIG. 4 is a first structural block diagram of a mobile terminal according to an embodiment of the present disclosure;

FIG. 5 is a second structural block diagram of a mobile terminal according to an embodiment of the present disclosure; and

FIG. 6 is a schematic structural diagram of hardware of a mobile terminal according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are some but not all of the embodiments of the present disclosure.

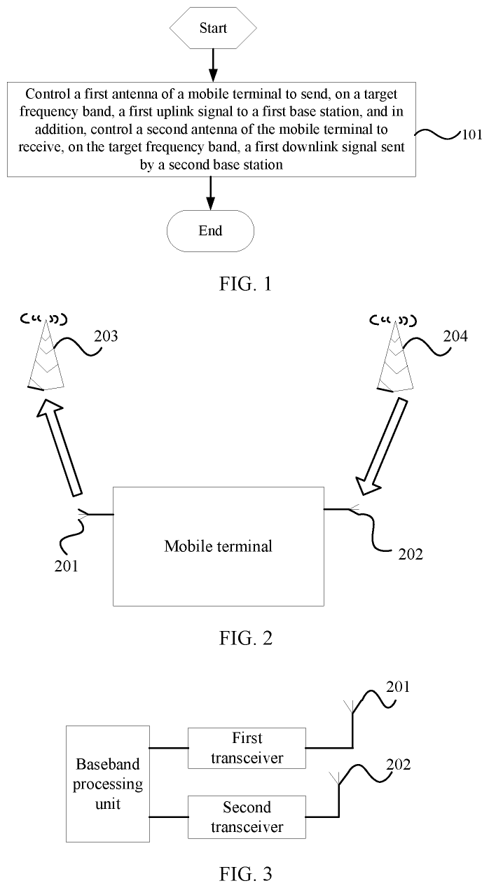

An embodiment of the present disclosure provides a communication method for a mobile terminal, where the mobile terminal includes at least two antennas. As shown in FIG. 1, the method includes the following steps.

Step 101: Control a first antenna of the mobile terminal to send, on a target frequency band, a first uplink signal to a first base station, and in addition, control a second antenna of the mobile terminal to receive, on the target frequency band, a first downlink signal sent by a second base station.

The first base station is a base station in communication connection to the first antenna, and the second base station is a base station in communication connection to the second antenna. A setting position of the first base station is different from that of the second base station. The first base station is one of the antennas on the mobile terminal, and the second antenna is another antenna, different from the first base station, on the mobile terminal.

It can be learned that in this embodiment of the present disclosure, at the same moment, sending of an uplink signal and receiving of a downlink signal are implemented by different antennas by using the same frequency range, and in addition, at this same moment, the uplink signal and the downlink signal correspond to different base stations. In other words, the uplink signal is sent by the mobile terminal to the first base station, and the downlink signal is sent by the second base station to the mobile terminal.

The uplink signal and the downlink signal use different antennas, and correspond to different base stations, so that isolation between the uplink signal and the downlink signal is increased. Therefore, interference by the uplink signal on the downlink signal during simultaneous working at the same frequency is greatly reduced.

Optionally, the step of controlling a first antenna of the mobile terminal to send, on a target frequency band, a first uplink signal to a first base station includes: adjusting a radiation direction of the first antenna of the mobile terminal towards a first direction, and controlling the first antenna to send, on the target frequency band, the first uplink signal to the first base station, where the first direction is a direction from the first antenna to the first base station.

The antenna on the mobile terminal is directional adjustable. Therefore, when the mobile terminal sends, by using the first antenna, the first uplink signal to the first base station, by adjusting the radiation direction of the first antenna, the first antenna sends the first uplink signal towards the first base station. That is, energy of the first uplink signal is bound in a specific small area, so as to further reduce interference by the first uplink signal on the first downlink signal.

Further, a beamforming technology may be used to adjust the radiation direction of the first antenna of the mobile terminal towards the first direction. It may be understood that the technology used to adjust the radiation direction of the first antenna of the mobile terminal towards the first direction is not limited to the beamforming technology.

Optionally, the step of controlling a second antenna of the mobile terminal to receive, on the target frequency band, a first downlink signal sent by a second base station includes: adjusting a radiation direction of the second antenna of the mobile terminal towards a second direction, and controlling the second antenna to receive, on the target frequency band, the first downlink signal sent by the second base station, where the second direction is a direction from the second antenna to the second base station.

The antenna on the mobile terminal is directional adjustable. Therefore, when the mobile terminal receives, by using the second antenna, the first downlink signal sent by the second base station, by adjusting the radiation direction of the second antenna, the second antenna receives the first downlink signal towards the second base station. That is, energy of the first downlink signal is bound in a specific small area, so as to further reduce interference by the first downlink signal on the first uplink signal.

Further, a beamforming technology may be used to adjust the radiation direction of the second antenna of the mobile terminal towards the second direction. It may be understood that the technology used to adjust the radiation direction of the second antenna of the mobile terminal towards the second direction is not limited to the beamforming technology.

Optionally, as shown in FIG. 3, the first antenna 201 is connected to a baseband processing unit of the mobile terminal through a first transceiver, and the second antenna 202 is connected to the baseband processing unit through a second transceiver; and before the steps of controlling a first antenna of the mobile terminal to send, on a target frequency band, a first uplink signal to a first base station, and in addition, controlling a second antenna of the mobile terminal to receive, on the target frequency band, a first downlink signal sent by a second base station, the method further includes: controlling the first transceiver to be in a sending state, and controlling the second transceiver to be in a receiving state.

In other words, in this embodiment of the present disclosure, different antennas are electrically connected to the baseband processing unit through different transceivers. Each transceiver has two working states: a sending state and a receiving state. Therefore, each antenna and the transceiver connected to the antenna may determine, based on an actual scenario, whether the antenna and the transceiver should be in a sending state or a receiving state.

Optionally, the method further includes:

controlling the first antenna to receive, on the target frequency band, a second downlink signal sent by the first base station, and in addition, controlling the second antenna to send, on the target frequency band, a second uplink signal to the second base station.

In other words, in this embodiment of the present disclosure, the first antenna may also be used as a receiving antenna, the second antenna may also be used as a sending antenna, and the mobile terminal may also, at the same moment by using the same frequency range, utilize the first antenna to receive the second downlink signal sent by the first base station and utilize the second antenna to send the second uplink signal to the second base station.

Further, the first antenna is connected to a baseband processing unit of the mobile terminal through a first transceiver, and the second antenna is connected to the baseband processing unit through a second transceiver; and before the steps of controlling the first antenna to receive, on the target frequency band, a second downlink signal sent by the first base station, and in addition, controlling the second antenna to send, on the target frequency band, a second uplink signal to the second base station, the method further includes: controlling the first transceiver to be in a receiving state, and controlling the second transceiver to be in a sending state.

It can be learned from the foregoing that each antenna on the mobile terminal may be used as a sending antenna or a receiving antenna. Whether the antenna is specifically used as the sending antenna or the receiving antenna depends on a specific state of a transceiver connected to the antenna. When a transceiver is in a sending state, an antenna connected to the transceiver is used as a sending antenna; and when a transceiver is in a receiving state, an antenna connected to the transceiver is used as a receiving antenna. It can be learned that in this embodiment of the present disclosure, different antennas are connected to the baseband processing unit through different transceivers, so that each antenna can be switched between sending and receiving, and communication between the mobile terminal and the base station is further facilitated.

In conclusion, the antennas on the mobile terminal are in communication connection to different base stations respectively. Specifically, as shown in FIG. 2, the first antenna 201 is in communication connection to the first base station 203, and the second antenna 202 is in communication connection to the second base station 204. Therefore, when the mobile terminal works, the two antennas simultaneously work in the same frequency range. The first antenna 201 utilizes the beamforming technology to send the uplink signal towards the first base station 203, and in addition, the second antenna 202 utilizes the beamforming technology to adjust the direction towards the second base station 204, and receives the downlink signal sent by the second base station 204. Therefore, in this embodiment of the present disclosure, the multi-antenna technology and the beamforming technology are utilized, so that the mobile terminal may perform communication and data transmission at the same time by using the same frequency range, and use efficiency of a frequency domain and a time domain is improved.

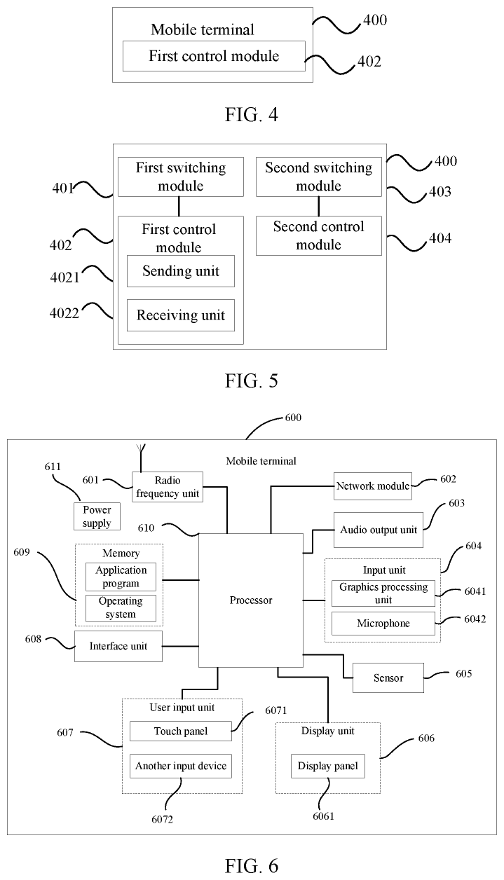

An embodiment of the present disclosure further provides a mobile terminal, where the mobile terminal includes at least two antennas. As shown in FIG. 4, the mobile terminal 400 includes:

a first control module 402, configured to: control a first antenna of the mobile terminal to send, on a target frequency band, a first uplink signal to a first base station, and in addition, control a second antenna of the mobile terminal to receive, on the target frequency band, a first downlink signal sent by a second base station, where

the first base station is a base station in communication connection to the first antenna, and the second base station is a base station in communication connection to the second antenna.

Optionally, as shown in FIG. 5, the first control module 402 includes:

a sending unit 4021, configured to: adjust a radiation direction of the first antenna of the mobile terminal towards a first direction, and control the first antenna to send, on the target frequency band, the first uplink signal to the first base station, where

the first direction is a direction from the first antenna to the first base station.

Optionally, as shown in FIG. 5, the first control module 402 includes:

a receiving unit 4022, configured to: adjust a radiation direction of the second antenna of the mobile terminal towards a second direction, and control the second antenna to receive, on the target frequency band, the first downlink signal sent by the second base station, where

the second direction is a direction from the second antenna to the second base station.

Optionally, the first antenna is connected to a baseband processing unit of the mobile terminal through a first transceiver, and the second antenna is connected to the baseband processing unit through a second transceiver. As shown in FIG. 5, the mobile terminal 400 further includes:

a first switching module 401, configured to: control the first transceiver to be in a sending state, and control the second transceiver to be in a receiving state.

Optionally, as shown in FIG. 5, the mobile terminal 400 further includes:

a second control module 404, configured to: control the first antenna to receive, on the target frequency band, a second downlink signal sent by the first base station, and in addition, control the second antenna to send, on the target frequency band, a second uplink signal to the second base station.

Optionally, the first antenna is connected to a baseband processing unit of the mobile terminal through a first transceiver, and the second antenna is connected to the baseband processing unit through a second transceiver. As shown in FIG. 5, the mobile terminal 400 further includes:

a second switching module 403, configured to: control the first transceiver to be in a receiving state, and control the second transceiver to be in a sending state.

It can be learned from the foregoing that, according to the mobile terminal 400 in this embodiment of the present disclosure, the first antenna is controlled to send the uplink signal to the first base station, and in addition, the second antenna is controlled to receive the downlink signal sent by the second base station, both of which use the same frequency range. At the same moment, the uplink signal and the downlink signal of the mobile terminal use the same frequency range to work simultaneously, and do not affect each other. Therefore, utilization of a frequency domain and a time domain by a communications system is improved.

An embodiment of the present disclosure further provides a mobile terminal. As shown in FIG. 6, the mobile terminal 600 includes but is not limited to: a radio frequency unit 601, a network module 602, an audio output unit 603, an input unit 604, a sensor 605, a display unit 606, a user input unit 607, an interface unit 608, a memory 609, a processor 610, a power supply 611, and other components. A person skilled in the art may understand that the structure of the mobile terminal shown in FIG. 6 does not constitute a limitation to the mobile terminal. The mobile terminal may include more or fewer components than that shown in the figure, or a combination of some components, or an arrangement of different components. In this embodiment of the present disclosure, the mobile terminal includes but is not limited to a mobile phone, a tablet computer, a notebook computer, a palmtop computer, a vehicle-mounted terminal, a wearable device, a pedometer, or the like.

The processor 610 is configured to: control a first antenna of the mobile terminal to send, on a target frequency band, a first uplink signal to a first base station, and in addition, control a second antenna of the mobile terminal to receive, on the target frequency band, a first downlink signal sent by a second base station, where the first base station is a base station in communication connection to the first antenna, and the second base station is a base station in communication connection to the second antenna.

Therefore, according to the mobile terminal 600 in this embodiment of the present disclosure, the first antenna is controlled to send the uplink signal to the first base station, and in addition, the second antenna is controlled to receive the downlink signal sent by the second base station, both of which use the same frequency range. At the same moment, the uplink signal and the downlink signal of the mobile terminal use the same frequency range to work simultaneously, and do not affect each other. Therefore, utilization rates of a frequency domain and a time domain by a communications system are improved.

It should be understood that in this embodiment of the present disclosure, the radio frequency unit 601 may be configured to receive and transmit information, or receive and transmit signals during a call. Specifically, the radio frequency unit 601 receives downlink data from a base station, and transmits the downlink data to the processor 610 for processing; and in addition, transmits uplink data to the base station. Generally, the radio frequency unit 601 includes but is not limited to at least two antennas, at least one amplifier, a transceiver, a coupler, a low noise amplifier, a duplexer, and the like. In addition, the radio frequency unit 601 may also communicate with another device through a wireless communications system and network.

The mobile terminal provides a user with wireless broadband Internet access through the network module 602, for example, helps the user send and receive emails, browse web pages, and access streaming media.

The audio output unit 603 may convert audio data received by the radio frequency unit 601 or the network module 602 or stored in the memory 609 into an audio signal, and output the audio signal into sound. In addition, the audio output unit 603 may also provide audio output related to a specific function performed by the mobile terminal 600 (for example, call signal receiving sound or message receiving sound). The audio output unit 603 includes a speaker, a buzzer, a receiver, and the like.

The input unit 604 is configured to receive an audio signal or a video signal. The input unit 604 may include a graphics processing unit (GPU) 6041 and a microphone 6042. The graphics processing unit 6041 is configured to process image data of a static picture or a video obtained by an image capture apparatus (for example, a camera) in video capture mode or image capture mode. A processed image frame may be displayed on the display unit 606. The image frame processed by the graphics processing unit 6041 may be stored in the memory 609 (or another storage medium) or sent via the radio frequency unit 601 or the network module 602. The microphone 6042 may receive sound and can process such sound into audio data. Processed audio data may be converted, in telephone call mode, into a format that may be sent to a mobile communication base station via the radio frequency unit 601 for output.

The mobile terminal 600 further includes at least one sensor 605, for example, a light sensor, a motion sensor, and other sensors. Specifically, the light sensor includes an ambient light sensor and a proximity sensor, where the ambient light sensor may adjust brightness of the display panel 6061 based on brightness of ambient light, and the proximity sensor may turn off the display panel 6061 and/or backlight when the mobile terminal 600 moves towards the ear. As a motion sensor, an accelerometer sensor may detect magnitude of acceleration in various directions (usually three axes), may detect magnitude and the direction of gravity when stationary, may be configured to identify postures of the mobile terminal (such as horizontal and vertical screen switch, related games, and magnetometer posture calibration), may perform functions related to vibration identification (such as a pedometer and a knock), and the like. The sensor 605 may further include a fingerprint sensor, a pressure sensor, an iris sensor, a molecular sensor, a gyroscope, a barometer, a hygrometer, a thermometer, an infrared sensor, or the like. Details are not described herein.

The display unit 606 is configured to display information input by the user or information provided to the user. The display unit 606 may include the display panel 6061, and the display panel 6061 may be configured in a form of a liquid crystal display (LCD), an organic light-emitting diode (OLED), or the like.

The user input unit 607 may be configured to receive input numeric or character information, and generate key signal inputs related to user settings and function control of the mobile terminal. Specifically, the user input unit 607 includes a touch panel 6071 and another input device 6072. The touch panel 6071, also called a touch screen, may collect a touch operation of the user on or near the touch panel 6071 (For example, the user uses any suitable object or accessory such as a finger or a stylus to operate on or near the touch panel 6071). The touch panel 6071 may include two parts: a touch detection apparatus and a touch controller. The touch detection apparatus detects a touch position of the user, detects a signal brought by the touch operation, and transmits the signal to the touch controller. The touch controller receives touch information from the touch detection apparatus, converts the touch information into contact coordinates, transmits the contact coordinates to the processor 610, receives a command sent by the processor 610, and executes the command. In addition, the touch panel 6071 may be implemented in various types such as resistive, capacitive, infrared, and surface acoustic wave. In addition to the touch panel 6071, the user input unit 607 may further include the another input device 6072. Specifically, the another input device 6072 may include but is not limited to a physical keyboard, function keys (such as a volume control key and a switch key), a trackball, a mouse, and a joystick. Details are not described herein.

Further, the touch panel 6071 may cover the display panel 6061. When detecting a touch operation on or near the touch panel 6071, the touch panel 6071 transmits the touch operation to the processor 610 to determine a type of a touch event. Then the processor 610 provides corresponding visual output on the display panel 6061 based on the type of the touch event. Although in FIG. 6, the touch panel 6071 and the display panel 6061 are configured as two independent components to implement input and output functions of the mobile terminal, in some embodiments, the touch panel 6071 and the display panel 6061 may be integrated to implement the input and output functions of the mobile terminal. Details are not limited herein.

The interface unit 608 is an interface for connecting an external apparatus to the mobile terminal 600. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, an earphone port, and the like. The interface unit 608 may be configured to receive an input (for example, data information and power) from the external apparatus and transmit the received input to one or more elements in the mobile terminal 600, or transmit data between the mobile terminal 600 and the external apparatus.

The memory 609 may be configured to store software programs and various data. The memory 609 may mainly include a program storage area and a data storage area. The program storage area may store an operating system, an application program required by at least one function (such as a sound playback function and an image playback function), and the like. The data storage area may store data (such as audio data and a phone book) created based on use of the mobile phone, and the like. In addition, the memory 609 may include a high-speed random access memory or a nonvolatile memory, for example, at least one disk storage device, a flash memory, or another volatile solid-state storage device.

The processor 610 is a control center of the mobile terminal, connects various parts of the entire mobile terminal by using various interfaces and circuits, and performs various functions of the mobile terminal and processes data by running or executing software programs and/or modules stored in the memory 609 and invoking data stored in the memory 609, so as to monitor the mobile terminal as a whole. The processor 610 may include one or more processing units. Optionally, the processor 610 may integrate an application processor with a modem processor. The application processor mainly processes the operating system, a user interface, the application program, and the like, and the modem processor mainly processes wireless communication. It may be understood that the foregoing modem processor may not be integrated into the processor 610.

The mobile terminal 600 may further include the power supply 611 (for example, a battery) configured to supply power to various components. Optionally, the power supply 611 may be logically connected to the processor 610 through a power management system, so as to implement functions such as managing charging, discharging, and power consumption through the power management system.

In addition, the mobile terminal 600 includes some function modules not shown. Details are not described herein.

An embodiment of the present disclosure further provides a computer readable storage medium, storing a computer program, where when the computer program is executed by the processor, the processes of the foregoing embodiment of the communication method for a mobile terminal are implemented, and the same technical effects can be achieved. To avoid repetition, details are not described herein again. The computer readable storage medium may be a read-only memory (ROM), a random access memory (RAM), a magnetic disk, a compact disc, or the like.

It should be noted that in this specification, the terms “comprise”, “include” and any other variants thereof are intended to cover non-exclusive inclusion, so that a process, a method, an article, or an apparatus that includes a series of elements not only includes these very elements, but may also include other elements not expressly listed, or also include elements inherent to this process, method, article, or apparatus. Without being subject to further limitations, an element defined by a phrase “including a . . . ” does not exclude presence of other identical elements in the process, method, article, or apparatus that includes the very element.

By means of the foregoing description of the embodiments, a person skilled in the art may clearly understand that the method in the foregoing embodiments may be implemented by software with a necessary general hardware platform. Certainly, the method in the foregoing embodiments may also be implemented by hardware. However, in many cases, the former is a preferred embodiment. Based on such an understanding, the technical solutions of the present disclosure essentially, or the part contributing to the related technologies may be implemented in a form of a computer software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of the present disclosure.

The embodiments of the present disclosure are described above with reference to the accompanying drawings, but the present disclosure is not limited to the foregoing specific implementations. The foregoing specific implementations are merely schematic instead of restrictive. Under enlightenment of the present disclosure, a person of ordinary skills in the art may make many forms without departing from the protection scope of aims of the present disclosure and claims, all of which fall within the protection of the present disclosure.

The optional implementations of the present disclosure are described above. It should be noted that a person of ordinary skill in the art may further make some improvements and refinements without departing from the principles described in the present disclosure, and these improvements and refinements shall also fall within the protection scope of the present disclosure.

What is claimed is:

1. A communication method, operable by a mobile terminal, wherein the mobile terminal comprises at least two antennas; and the communication method comprises:
controlling a first antenna of the mobile terminal to send, on a target frequency band, a first uplink signal to a first base station; and
controlling a second antenna of the mobile terminal to receive, on the target frequency band, a first downlink signal sent by a second base station, wherein
the first base station is a base station in communication connection to the first antenna, and the second base station is a base station in communication connection to the second antenna.

2. The communication method according to claim 1, wherein controlling the first antenna of the mobile terminal to send, on the target frequency band, the first uplink signal to the first base station further comprises:
adjusting a radiation direction of the first antenna of the mobile terminal towards a first direction; and
controlling the first antenna to send, on the target frequency band, the first uplink signal to the first base station, wherein
the first direction is a direction from the first antenna to the first base station.

3. The communication method according to claim 1, wherein controlling the second antenna of the mobile terminal to receive, on the target frequency band, the first downlink signal sent by the second base station comprises:
adjusting a radiation direction of the second antenna of the mobile terminal towards a second direction; and
controlling the second antenna to receive, on the target frequency band, the first downlink signal sent by the second base station, wherein
the second direction is a direction from the second antenna to the second base station.

4. The communication method according to claim 1, wherein the first antenna is connected to a baseband processing unit of the mobile terminal through a first transceiver, and the second antenna is connected to the baseband processing unit through a second transceiver; and
before controlling the first antenna of the mobile terminal to send, on the target frequency band, the first uplink signal to the first base station; and controlling the second antenna of the mobile terminal to receive, on the target frequency band, the first downlink signal sent by the second base station, the communication method further comprises:
controlling the first transceiver to be in a sending state; and
controlling the second transceiver to be in a receiving state.

5. The communication method according to claim 1, wherein the communication method further comprises:
controlling the first antenna to receive, on the target frequency band, a second downlink signal sent by the first base station; and
controlling the second antenna to send, on the target frequency band, a second uplink signal to the second base station.

6. The communication method according to claim 5, wherein the first antenna is connected to a baseband processing unit of the mobile terminal through a first transceiver, and the second antenna is connected to the baseband processing unit through a second transceiver; and
before controlling the first antenna to receive, on the target frequency band, the second downlink signal sent by the first base station; and controlling the second antenna to send, on the target frequency band, the second uplink signal to the second base station, the communication method further comprises:
controlling the first transceiver to be in a receiving state; and
controlling the second transceiver to be in a sending state.

7. A mobile terminal, comprising at least two antennas, wherein the mobile terminal further comprises:
a first control module, configured to:
control a first antenna of the mobile terminal to send, on a target frequency band, a first uplink signal to a first base station; and
control a second antenna of the mobile terminal to receive, on the target frequency band, a first downlink signal sent by a second base station, wherein
the first base station is a base station in communication connection to the first antenna, and the second base station is a base station in communication connection to the second antenna.

8. The mobile terminal according to claim 7, wherein the first control module comprises:
a sending unit, configured to:
adjust a radiation direction of the first antenna of the mobile terminal towards a first direction; and
control the first antenna to send, on the target frequency band, the first uplink signal to the first base station, wherein
the first direction is a direction from the first antenna to the first base station.

9. The mobile terminal according to claim 7, wherein the first control module further comprises:
a receiving unit, configured to:
adjust a radiation direction of the second antenna of the mobile terminal towards a second direction; and
control the second antenna to receive, on the target frequency band, the first downlink signal sent by the second base station, wherein
the second direction is a direction from the second antenna to the second base station.

10. The mobile terminal according to claim 7, wherein the first antenna is connected to a baseband processing unit of the mobile terminal through a first transceiver, and the second antenna is connected to the baseband processing unit through a second transceiver; and
the mobile terminal further comprises:
a first switching module, configured to:
control the first transceiver to be in a sending state; and
control the second transceiver to be in a receiving state.

11. The mobile terminal according to claim 7, wherein the mobile terminal further comprises:
a second control module, configured to:
control the first antenna to receive, on the target frequency band, a second downlink signal sent by the first base station; and
control the second antenna to send, on the target frequency band, a second uplink signal to the second base station.

12. The mobile terminal according to claim 11, wherein the first antenna is connected to a baseband processing unit of the mobile terminal through a first transceiver, and the second antenna is connected to the baseband processing unit through a second transceiver; and
the mobile terminal further comprises:
a second switching module, configured to:
control the first transceiver to be in a receiving state; and
control the second transceiver to be in a sending state.

13. A non-transitory computer-readable storage medium, storing a computer program, wherein when the computer program is executed by a processor, performs a communication method operable by a mobile terminal comprising at least two antennas, the communication method comprising:
controlling a first antenna of the mobile terminal to send, on a target frequency band, a first uplink signal to a first base station; and
controlling a second antenna of the mobile terminal to receive, on the target frequency band, a first downlink signal sent by a second base station, wherein
the first base station is a base station in communication connection to the first antenna, and the second base station is a base station in communication connection to the second antenna.

14. The non-transitory computer-readable storage medium according to claim 13, wherein controlling the first antenna of the mobile terminal to send, on the target frequency band, the first uplink signal to the first base station further comprises:
adjusting a radiation direction of the first antenna of the mobile terminal towards a first direction; and
controlling the first antenna to send, on the target frequency band, the first uplink signal to the first base station, wherein
the first direction is a direction from the first antenna to the first base station.

15. The non-transitory computer-readable storage medium according to claim 13, wherein controlling the second antenna of the mobile terminal to receive, on the target frequency band, the first downlink signal sent by the second base station comprises:
adjusting a radiation direction of the second antenna of the mobile terminal towards a second direction; and
controlling the second antenna to receive, on the target frequency band, the first downlink signal sent by the second base station, wherein
the second direction is a direction from the second antenna to the second base station.

16. The non-transitory computer-readable storage medium according to claim 13, wherein the first antenna is connected to a baseband processing unit of the mobile terminal through a first transceiver, and the second antenna is connected to the baseband processing unit through a second transceiver; and
before controlling the first antenna of the mobile terminal to send, on the target frequency band, the first uplink signal to the first base station; and controlling the second antenna of the mobile terminal to receive, on the target frequency band, the first downlink signal sent by the second base station, the communication method further comprises:
controlling the first transceiver to be in a sending state; and
controlling the second transceiver to be in a receiving state.

17. The non-transitory computer-readable storage medium according to claim 13, wherein the communication method further comprises:
controlling the first antenna to receive, on the target frequency band, a second downlink signal sent by the first base station; and
controlling the second antenna to send, on the target frequency band, a second uplink signal to the second base station.

18. The non-transitory computer-readable storage medium according to claim 17, wherein the first antenna is connected to a baseband processing unit of the mobile terminal through a first transceiver, and the second antenna is connected to the baseband processing unit through a second transceiver; and
before controlling the first antenna to receive, on the target frequency band, the second downlink signal sent by the first base station; and controlling the second antenna to send, on the target frequency band, the second uplink signal to the second base station, the communication method further comprises:
controlling the first transceiver to be in a receiving state; and
controlling the second transceiver to be in a sending state.
